(19) United States
(12) Patent Application Publication
(10) Pub. No.: US 2004/0240428 A1
(43) Pub. Date: Dec. 2, 2004

(54) SDH/SONET-based data transmitting method

(76) Inventor: Zhangzhen Jiang, Shenzhen (CN)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/752,346

(22) Filed: Jan. 6, 2004

(30) Foreign Application Priority Data
Jan. 7, 2003 (CN) 03101228-0

(51) Int. Cl. H04L 12/28

(52) U.S. Cl. 370/351; 370/395.21

(57) ABSTRACT

An SDH/SONET network-based data transmitting method includes the steps of inserting label information in service data which is being transferred, mapping the service data to synchronous digital transmission channels in the SDH/SONET network according to the label information inserted, and transferring the service data via the synchronous digital transmission channels in the SDH/SONET network.

### FIELD OF THE INVENTION

The present invention relates to network communications industry, in particular to a method of transmitting broadband data via SDH/SONET network.

BACKGROUND OF THE INVENTION

Today, more and more broadband service data has to be transferred via SDH/SONET networks. There are two traditional methods of transferring broadband service data via SDH/SONET networks:

According to one method, data is directly mapped from broadband data interfaces to digital transmission channels in SDH/SONET networks, each broadband data interface corresponds to a transmission channel, and each subscriber owns one or more independent synchronous digital transmission channels, as shown in FIG. 1; the data processing steps are as follows: a synchronous digital transmission channel receives messages from a broadband data interface, and maps the messages to one or more virtual containers according to Link Access Procedure-SDH (LAPS), Generic Framing Procedure (GFP), or Point-to-Point Protocol/High level Data Link Control (PPP/HDLC); then a single or a cascade of virtual containers carrying broadband data messages are transferred in the SDH/SONET network.

According to the other method, data from a plurality of interfaces is converged and then mapped to transfer in independent synchronous digital transmission channels, as shown in FIG. 2; the data processing steps are as follows: a synchronous digital transmission channel receives messages from broadband data interfaces and converges the messages of the same subscriber, and then maps the messages to the same destination address to one or more virtual containers in the SDH/SONET network according to LAPS, GFP, or PPP/HDLC protocol; finally, a single or a cascade of virtual containers carrying broadband data messages are transferred in the SDH/SONET network; messages of the same subscriber but to different destinations are mapped to different channels, i.e., a subscriber may own two or more independent synchronous digital transmission channels.

From above description, it is obvious that there are following disadvantages in traditional SDH/SONET-based data transmitting methods: first, a synchronous digital transmission channel can only be allocated to one subscriber and should be reserved for the subscriber even when the subscriber is not using the channel, which results in low utilization efficiency of synchronous digital transmission channels and the subscriber's high expense; at the same time, if the synchronous digital transmission channel leased by a subscriber are connected into a logical ring, some channels have to be shut down in order to avoid forming broadcasting ring, which causes that expensive synchronous digital transmission channels are laid idle and investments are wasted; third, said methods will lead to a large amount of redundant synchronous digital transmission channels, thus limited transmission resources are wasted; the redundant synchronous digital transmission channels are usually backup to protect with spanning tree protocol, the protective switching time of which is as high as tens of seconds, unable to meet the requirement for protection, and even resulting in oscillation; fourth, for the same synchronous digital transmission channel, said two methods are unable to distinguish between data belonging to the same subscriber but with different service priorities, thus it can not process said data differently during network congestion or protection and is unable to provide satisfactory services for subscribers.

### SUMMARY OF THE INVENTION

The object of the present invention is to provide a SDH/SONET-based data transmitting method to improve utilization efficiency of SDH/SONET channels carrying broadband data and to ensure Quality of Service (QOS) of data transmission service.

The present invention is implemented as follows: said SDH/SONET-based data transmitting method comprises: first, inserting label information in the service data which is being transferred; then, mapping the service data to synchronous digital transmission channels in SDH/SONET network according to the label information inserted, and transferring the service data via said synchronous digital transmission channels in SDH/SONET network; the receiving end distinguishing service data of different subscribers according to the label information and distributing the data to different subscribers.

Said label information comprises subscriber ID and further comprises QOS levels.

Said label information is inserted at front or back of the field carrying data link layer information in the service data.

Said service data comprises: broadband service data and converged broadband service data.

Said label information is inserted in according to Multi-protocol Label Switching (MPLS).

Said labels are labels with different label numbers created according to service data transmission path and QOS level, each label corresponds to a synchronous digital transmission channel;

Said step of inserting label information in the service data to be transferred comprises: determining the label number according to the source, destination, and QOS level of the service data to be transferred, and then mapping said service data to said label.

Said step of mapping service data to a synchronous digital transmission channel in SDH/SONET network according to label information inserted comprises: determining the synchronous digital transmission channel for service data according to the label number and the mapping relation between labels and channels, and mapping said service data to said synchronous digital transmission channel.

Said step of mapping service data to a synchronous digital transmission channel in SDH/SONET network according to label information inserted comprises: mapping said broadband service data to a Resilient Packet Ring (RPR) according to the label information inserted, and then mapping said service data to a channel in SDH/SONET network.

Said method also comprises: if the synchronous digital transmission channel is congested, switching the service data with higher QOS level to another normal synchronous digital transmission channel to transfer according to QOS level information carried in the label of the service data.

When configuring the mapping relationship between service and labels, explicit directions are available for non-broadcasting paths, and a broadcasting tree is configured for the broadcasting source and all destinations, thus the broadcast is transmitted to every destination without broadcast repetition.

Seen from said scheme, a label is inserted in the broadband service data of different subscribers when transferring them via SDH/SONET network, the broadband service data is mapped to the same synchronous digital channel or to a RPR and then to a synchronous digital channel to transfer, so that a plurality of subscribers can share the same synchronous digital transmission channel; in addition, a logical connection can be established according to the label so as to determine the transmission paths for the service data, thus a broadcast ring can not produce. Therefore, according to the present invention, utilization efficiency of synchronous digital transmission channels in SDH/SONET network can be improved; in addition, when service interruption or transmission quality degradation occurs in a synchronous digital transmission channel, important service data connections in that channel can be switched to another normal synchronous digital transmission channel according to the subscribers, requirements for data transmission; furthermore, the present invention can also provide services with different QOS levels according to QOS level requirements to solve the problem of different levels of QOS protection for data service.

### BRIEF DESCRIPTION THE DRAWINGS

FIG. 1 is a schematic diagram 1 of traditional process of transferring broadband data via SDH/SONET network;

FIG. 2 is a schematic diagram 2 of traditional process of transferring broadband data via SDH/SONET network;

FIG. 3 is a schematic diagram 1 of the process of the method according to the present invention;

FIG. 4 is a schematic diagram 2 of the process of the method according to the present invention;

FIG. 5 is a flow chart of an embodiment of the method according to the present invention;

FIG. 6 shows one position where a label is inserted;

FIG. 7 shows the other position where a label is inserted;

FIG. 8 shows the format of MPLS-based label.

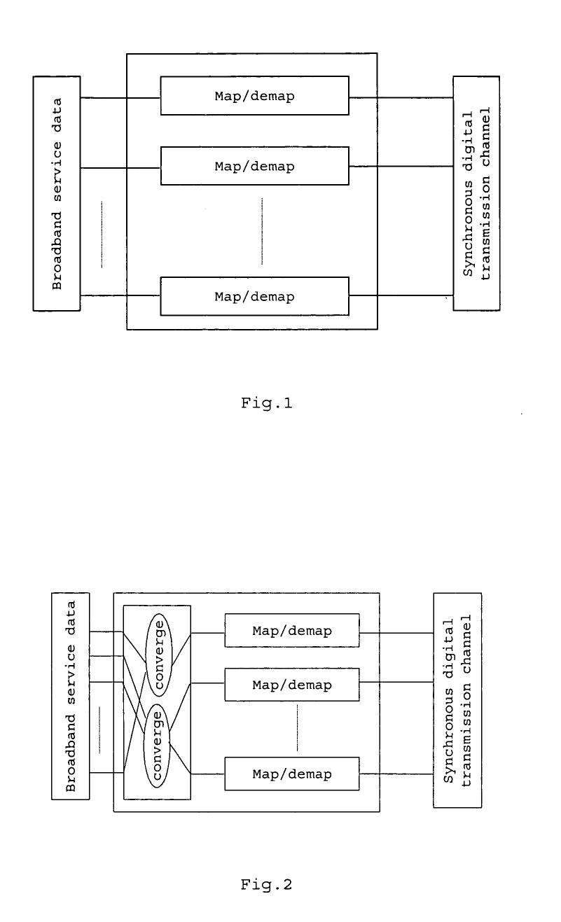

### DETAILED DESCRIPTION OF THE EMBODIMENT

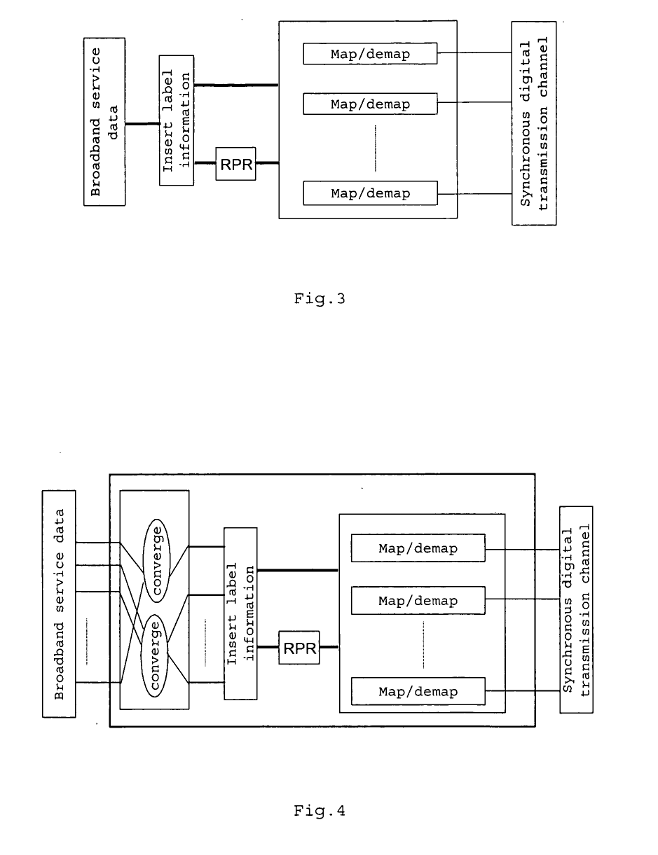

As shown in FIG. 3 and FIG. 4, according to the method of transmitting data via SDH/SONET network of the present invention, label information is inserted in the same type of broadband service data streams which belongs to the same subscriber, the same destination address, the same QOS, or with same other characteristics, then the broadband service data is mapped to the synchronous digital transmission channel to transfer or mapped to a RPR and then maps the synchronous digital transmission channel to transfer according to the label information.

An embodiment of the SDH/SONET-based data transmitting method according to the present invention is shown in FIG. 3, FIG. 4, and FIG. 5; wherein the embodiment comprises the following steps:

Step 1: inserting label information in broadband service data from a broadband data interface or a data converging module according to preset rules; if the same type of label information has been inserted in said broadband service data, it being unnecessary to insert said label information;

Said label information comprises a number designed to distinguish service data of different subscribers and information indicating QOS level of said service data, etc.;

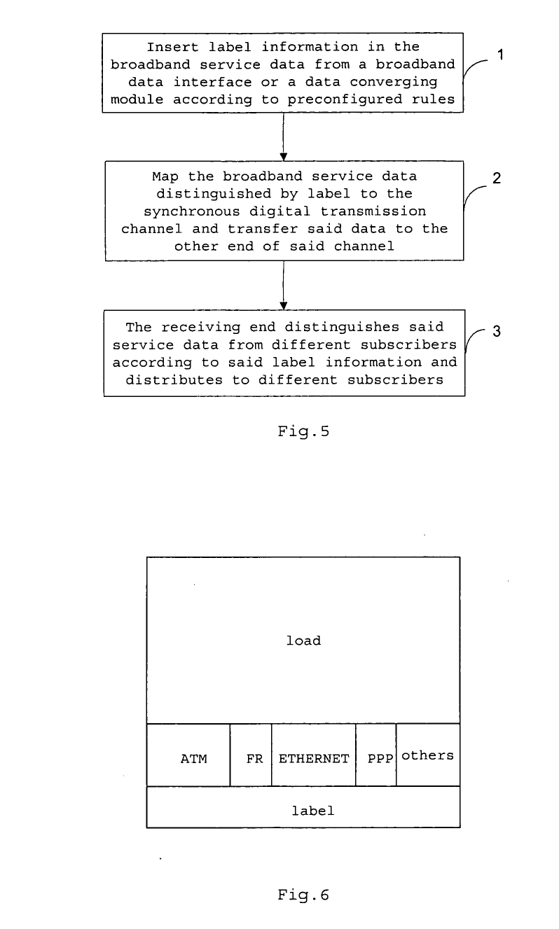

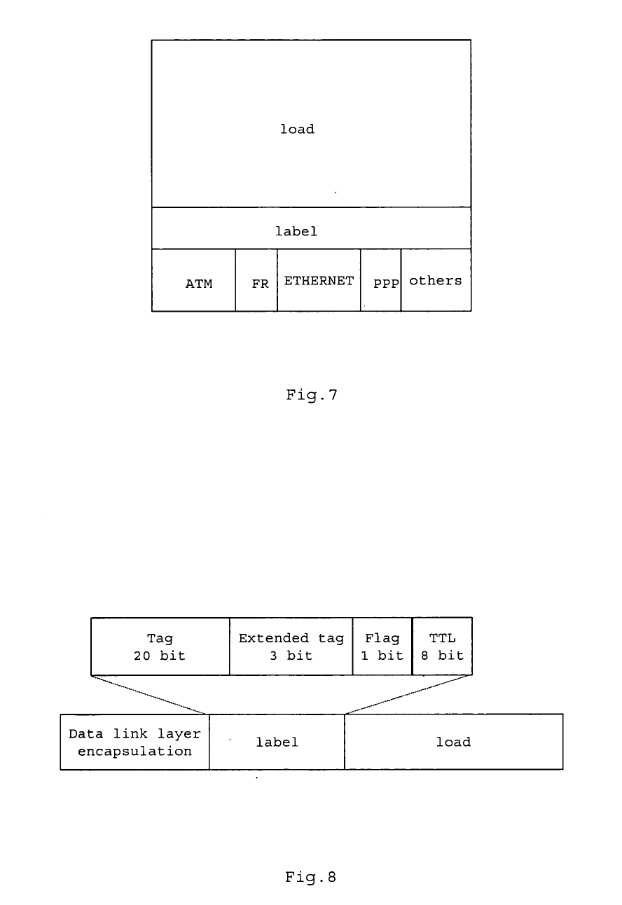

The label is usually inserted at front or back of data link layer, as shown in FIG. 6 and FIG. 7;

The rules for inserting labels may be MPLS rules or similar subscriber-defined rules. To adapt to data devices supporting labeled switching, standard MPLS label format may be employed, as shown in FIG. 8, wherein the label follows the header of encapsulation of data link layer and comprises a 20-bit tag, a 3-bit extended tag, a 1-bit flag, and a 8-bit Time To Live (TTL); if adaptation to data devices supporting labeled switching is unnecessary, other label defining rules may be employed to define label formats; a label carries identification information used to distinguish different service data, said identification information comprises a plurality of bits and its length can be determined according to the quantity of service data streams.

Step 2: directly mapping the service data identified with label to a synchronous digital transmission channel in SDH/SONET network, and then transferring said service data to the other end of said synchronous digital transmission channel;

According to the requirement for network transmission performance, the broadband service data can be mapped to a RPR and then mapped to a synchronous data transmission channel to transfer;

Labels may be created in advance in SDH/SONET network according to service data transmission paths and required QOS levels, and each label corresponds to logical connection of a specific QOS level, i.e., a mapping relationship table between labels and synchronous digital transmission channels is created with MPLS LDP protocol; when a label is to be inserted in some specific broadband service data, the label is chosen and determined according to transmission requirement of said service data, and then said service data is mapped to said label, then different services involving bandwidth, delay, dithering, packet loss rate, etc., may be provided for subscribers according to the label information.

If a subscriber takes a plurality of synchronous digital transmission channels on lease, label-based connections may be established for the subscriber. Such connections are logical connections and are mainly used to indicate target service channels, such as a label-forwarding table. In this way, each service data transmitting path is definite, so is the QOS of each path. For instance, there are two paths transmitting data synchronously between two points but their characteristics such as delay, dithering, and BER are different, for common forwarding rules, usually the shorter path is chosen or a path is disconnected through protocol (as a redundant path). Such a method can't take full advantage of bandwidth resource (especially expensive bandwidth resource in transmission network) between the two points; on the contrary, when virtual connections are established with labels, service data of higher QOS level may be transferred through quality paths, while service data of lower QOS level may be transferred through the other path, which is of lower quality.

Step 3: the receiving end of broadband service data can distinguish service data from different subscribers according to label information and distribute the service data to corresponding subscribers. Therefore, service data of a plurality of subscribers may be transferred via a single synchronous digital transmission channel. For example, in the case of Ethernet data transmission, A LAN of a plurality of subscribers employs the same VLAN and IP and even the same MAC address, and usually the service data has to be transferred via independent synchronous digital transmission channels; with the method of the present invention, when labels are inserted in the service data, only one synchronous digital transmission channel can transfer data of a plurality of subscribers.

Because the present invention specifies transmission paths for service data through inserting label information, explicit directions are available for non-broadcasting paths at configuring mapping rules, thus broadcasting ring will not occur, and each synchronous digital transmission channel for every subscriber may be fully utilized; even if the connections are configured into a ring due to the subscriber's fault, the ring may be eliminated through higher level protocols such as MPLS LDP protocol. For broadcast messages, a broadcasting tree can be configured for the broadcasting source and all destinations, so that the broadcast will be transmitted to every destination without broadcast repetition.

If MPLS is used to insert labels according to the prsent invention, service flow may be coordinated through (MPLS-Traffic Engineering) MPLS-TE technique to improve utilization efficiency of each synchronous digital transmission channel and provide protection for each connection; for instance, suppose that a subscriber establishes two connections of different QOS levels in the same synchronous digital transmission channel to transfer service data, if the synchronous digital transmission channel is congested, the service data with higher priority may be switched to a normal synchronous digital transmission channel, while protection for the service data with lower priority will be neglected.

1. (canceled)

2. An SDH/SONET network-based data transmitting method according to claim 12, wherein said label information comprises subscriber identification information ID.

3. An SDH/SONET network-based data transmitting method according to claim 2, wherein said label information further comprises QOS levels.

4. An SDH/SONET network-based data transmitting method according to claim 12, wherein said label information is inserted at front or back of a field carrying data link layer information in the service data.

5. An SDH/SONET network-based data ransmitting method according to claim 12, wherein said service data comprises: broadband service data and converged broadband service data.

6. An SDH/SONET network-based data transmitting method according to claim 12, wherein said label information is inserted in the service data according to MPLS rules.

7. An SDH/SONET network-based data transmitting method according to claim 12, wherein said label information comprises label numbers corresponding to service data transmission path and QOS level, each inserted label information corresponds to a synchronous digital transmission channel; and said step of inserting label information in the service data to be transferred comprises: determining a label number corresponding to a source, destination, and QOS level of the service data to be transferred, and mapping said service data to said label number.

8. An SDH/SONET network-based data transmitting method according to claim 7, wherein said step of mapping the service data to synchronous digital transmission channels in the SDH/SONET network according to the label information inserted comprises: determining the synchronous digital transmission channel for service data according to the label number and a mapping relation between labels and channels, and mapping said service data to said synchronous digital transmission channel.

9. An SDH/SONET network-based data transmitting method according to claim 12, wherein said step of mapping the service data to synchronous digital transmission channels in the SDH/SONET network according to the label information inserted comprises: mapping said service data to a Resilient Packet Ring (RPR) according to the label information inserted, and then mapping said service data to a channel in the SDH/SONET network.

10. An SDH/SONET-based data transmitting method according to claim 12, wherein said method also comprises: if the synchronous digital transmission channel is congested, switching service data with a higher QOS level to another synchronous digital transmission channel to transfer according to QOS level information carried in the label information of the service data.

11. An SDH/SONET-based data transmitting method according to claim 6, wherein explicit directions are available for non-broadcasting paths, and a broadcasting tree is configured for a broadcasting source and all destinations, such that the data is transmitted to every destination without broadcast repetition.

12. An SDH/SONET network-based method for transmitting service data of a pluarality of subscribers, comprising the steps of:
inserting label information in the service data which is being transferred;
mapping the service data to synchronous digital transmission channels in the SDH/SONET network according to the label information inserted; and
transferring the service data via said synchronous digital transmission channels in the SDH/SONET network to a receiving end, the receiving end distinguishing service data of different subscribers according to the label information and distributing the data to corresponding subscribers.

13. An SDH/SONET network-based data transmitting method according to claim 2, wherein said label information is inserted at front or back of a field carrying data link layer information in the service data.

14. An SDH/SONET network-based data transmitting method according to claim 3, wherein said label information is inserted at front or back of a field carrying data link layer information in the service data.
